(19) United States
(12) Patent Application Publication
(10) Pub. No.: US 2026/0056368 A1
(43) Pub. Date: Feb. 26, 2026

(54) OPTICAL WAVEGUIDE DEVICE, OPTICAL MODULATOR, AND OPTICAL TRANSMISSION APPARATUS

(71) Applicant: SUMITOMO OSAKA CEMENT CO., LTD., Tokyo (JP)

(72) Inventors: Makoto Shimada, Tokyo (JP); Hideki Ichimei, Tokyo (JP)

(21) Appl. No.: 18/875,931

(22) PCT Filed: Sep. 30, 2022
(86) PCT No.: PCT/JP2022/036842

§ 371 Date: Nov. 3, 2025

(51) Int. Cl. G02B 6/30

(52) U.S. Cl. CPC G02B 6/30

(57) ABSTRACT

An optical waveguide device includes an optical waveguide substrate on which an optical waveguide is provided, and a plurality of lenses that optically couple the optical waveguide and optical fibers, in which the optical waveguide includes at least one input waveguide to which input light is input and at least two output waveguides that output outputted light which forms output light, an end portion of the input waveguide and end portions of the output waveguide are formed on one same end surface of the optical waveguide substrate, at least three lenses respectively corresponding to the at least one input waveguide and the at least two output waveguides are disposed on the end surface, and the at least three lenses are configured with a lens array in which at least two lenses are integrally formed and a single lens.

### TECHNICAL FIELD

The present invention relates to an optical waveguide device, an optical modulator, and an optical transmission apparatus.

### BACKGROUND ART

In a high-frequency/large-capacity optical fiber communication system, an optical transmission apparatus, into which a waveguide type optical element (hereinafter, referred to as an optical modulation element) performing optical modulation is incorporated, is generally used. Among them, an optical modulation element in which a substrate is made of LiNbO3 (hereinafter, also referred to as LN) having an electro-optic effect is widely used in the high-frequency/large-capacity optical fiber communication system since the optical modulation element has a smaller optical loss and can achieve more broadband optical modulation characteristics than a modulation element using a semiconductor-based material, such as indium phosphide (InP), silicon (Si), or gallium arsenide (GaAs).

A modulation scheme in the optical fiber communication system accepts a trend of increasing transmission capacity in recent years, and a multi-level modulation or a transmission format incorporating polarization multiplexing in the multi-level modulation, such as quadrature phase shift keying (QPSK) or dual polarization-quadrature phase shift keying (DP-QPSK) are mainly used.

The acceleration of the spread of Internet services in recent years has led to a further increase in communication traffic, and studies on high-frequency and large-capacity optical communication systems are continuously conducted. On the other hand, the demand for reducing the size of the device remains unchanged, and in addition to reducing the size of the optical modulation element, efforts are underway to accommodate an electronic circuit and an optical modulation element in one package case, to integrate them into an optical modulation device, or the like.

For example, an optical modulation device in which an optical modulation element and a high-frequency driver amplifier that drives the optical modulation element are integrated and accommodated in one case and an optical input and output unit is disposed in parallel on one surface of the case, is proposed to achieve miniaturization and integration.

As such an optical modulation device, in related art, an optical modulation device in which a microlens array integrally including a plurality of lenses is provided on a light input and output surface of a substrate provided with an optical waveguide configuring the optical modulation element, is known (refer to Patent Literature No. 1).

In the optical modulation device, input light input from an input optical fiber is focused by one lens of the microlens array and is input into an input waveguide provided on the substrate. In addition, two outputted light components respectively output from two output waveguides provided on the substrate are collimated by each of the two lenses of the microlens array.

In addition, in the optical modulation device in which the microlens array integrally including the plurality of lenses is provided on the light input and output surface of the substrate on which the optical waveguide configuring the optical modulation element is provided, beam diameters of the input light and the outputted light are converted by selecting respective focal lengths between the microlens array and a coupling lens provided on the optical fiber, and the optical fiber and the optical modulation element are coupled to each other through the lens array.

In the optical modulation device, the microlens array is attached to the optical modulation element with an adhesive.

However, in the optical modulation device, when the microlens array is attached to the substrate, a thickness dimension of the adhesive in a focal direction of the microlens array may not be uniform over the entirety of the light input and output surface.

As a result, in the optical modulation device, there is a possibility that the microlens array is attached to the light input and output surface in a state where a gradient is provided. Therefore, there is a possibility that optical coupling loss between the optical modulation element and the optical fiber increases.

### CITATION LIST

### Patent Literature

[Patent Literature No. 1] Japanese Laid-open Patent Publication No. 2021-149036

### SUMMARY OF INVENTION

### Technical Problem

From the above background, in the optical waveguide device including the lens that couples the optical waveguide provided on the substrate and the optical fiber, it is required to suppress an increase in the optical coupling loss between the optical waveguide and the optical fiber due to a fixing structure between the substrate and the lens.

### Solution to Problem

In one aspect of the present invention, there is provided an optical waveguide device including a substrate on which an optical waveguide is provided, and a plurality of lenses that optically couple the optical waveguide and an optical fiber, in which the optical waveguide includes at least one input waveguide to which input light is input and at least two output waveguides that output outputted light which forms output light, an end portion of the input waveguide and an end portion of the output waveguide are formed on one same end surface of the substrate, at least three lenses respectively corresponding to the at least one input waveguide and the at least two output waveguides are disposed on the end surface, and the at least three lenses are configured with a lens array in which at least two lenses are integrally formed and a single lens.

According to another aspect of the present invention, in the optical waveguide device according to claim 1, the lens corresponding to the input waveguide and the lens corresponding to the one output waveguide are integrally formed in the lens array.

According to another aspect of the present invention, in the optical waveguide device according to claim 1, the lenses corresponding to the at least two output waveguides are integrally formed in the lens array.

According to another aspect of the present invention, in the optical waveguide device according to claim 1 or 3, the two output waveguides are provided on the substrate, and the two lenses respectively corresponding to the two output waveguides are integrally formed in the lens array.

According to another aspect of the present invention, in the optical waveguide device according to any one of claims 1 to 4, an angle of the input light with respect to an optical axis of the input waveguide is smaller than an angle of the output light with respect to an optical axis of the output waveguide.

According to another aspect of the present invention, in the optical waveguide device according to any one of claims 1 to 5, a lens corresponding to each of the two output waveguides includes an attachment surface that is attached to face the end surface, and the attachment surface is attached to the end surface such that reflected light of the output light from each of the output waveguides on the attachment surface is directed in a direction away from a direction of the other output waveguide.

According to another aspect of the present invention, the substrate is bonded to a support substrate, the lens includes an attachment surface that is attached to face the end surface, and the attachment surface is attached to the end surface such that reflected light of the output light from each of the output waveguides on the attachment surface is directed in a direction away from the support substrate.

In another aspect of the present invention, there is provided an optical modulator including the optical waveguide device according to any one of the above aspects, a case that accommodates the optical waveguide device, and an optical fiber that inputs a light wave to the optical waveguide or outputs a light wave from the optical waveguide from an outside of the case.

In another aspect of the present invention, there is provided an optical transmission apparatus including the optical modulator and an electronic circuit that outputs a modulation signal for causing the optical modulator to perform a modulation operation.

### Advantageous Effects of Invention

According to the present invention, in the optical waveguide device including the lens that couples the optical waveguide provided on the substrate and the optical fiber, an increase in the optical coupling loss between the optical waveguide and the optical fiber due to a fixing structure between the substrate and the lens can be suppressed.

### BRIEF DESCRIPTION OF DRAWINGS

FIG. 1 is a diagram illustrating a configuration of an optical modulator according to a first embodiment of the present invention.

FIG. 2 is a view illustrating an optical waveguide device, an optical axis of an optical waveguide at an input end of an optical modulation element, and a ray direction of a lens.

FIG. 3 is a diagram illustrating a configuration of an optical waveguide device according to a modification example of the first embodiment.

FIG. 4 is a diagram illustrating a configuration of an optical waveguide device according to a modification example of the first embodiment.

FIG. 5 is a diagram illustrating a configuration of an optical modulator according to a second embodiment of the present invention.

FIG. 6 is a diagram illustrating a configuration of an optical transmission apparatus according to the present invention.

### DESCRIPTION OF EMBODIMENTS

Hereinafter, embodiments of the present invention will be described with reference to the drawings.

### First Embodiment

First, a first embodiment will be described.

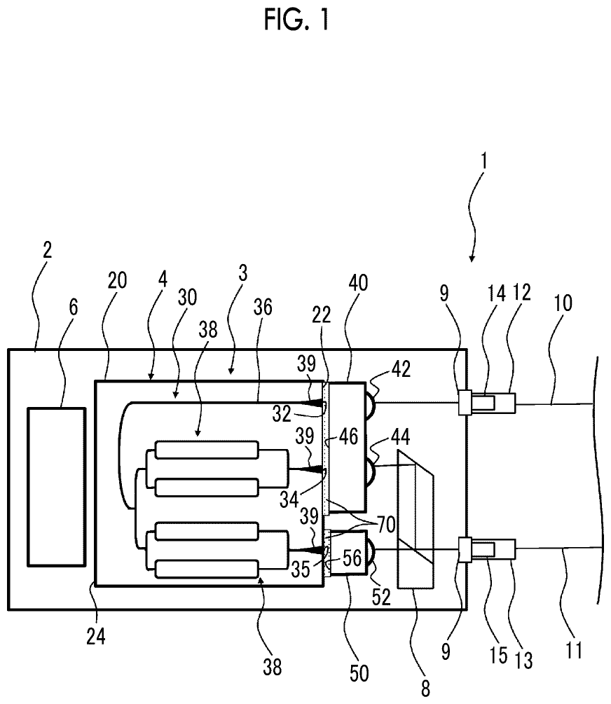

FIG. 1 is a diagram illustrating a configuration of an optical modulator 1 using an optical modulation element 4 that is an optical waveguide device according to the first embodiment of the present invention. In FIG. 1, a wave plate that rotates a polarization direction of output light from a lens 44 is not illustrated. In FIGS. 1 to 6, for convenience of description, an adhesive 70 is illustrated with a dot.

As illustrated in FIG. 1, the optical modulator 1 includes a case 2. An optical waveguide device 3 and a driver circuit element 6 are housed in the case 2.

An input optical fiber 10 and an output optical fiber 11 are provided on one side surface of the case 2. The input optical fiber 10 is an optical fiber that introduces input light into the optical modulation element 4. The output optical fiber 11 is an optical fiber that guides the modulated light (modulation light, outputted light) output from the optical modulation element 4 to the outside of the case 2. The input optical fiber 10 and the output optical fiber 11 are fixed to the case 2 by holding members 12 and 13, respectively. The holding members 12 and 13 hold coupling lenses 14 and 15, respectively. Mode field diameters of the input optical fiber 10 and the output optical fiber 11 are, for example, 10 μm.

In the case 2, an optical window 9 formed of a light transmitting material such as a glass material is provided at positions corresponding to the input optical fiber 10 and the output optical fiber 11 on a side surface in which the input optical fiber 10 and the output optical fiber 11 are provided. By providing the optical window 9, the case 2 has an airtight sealing structure in which airtightness is ensured.

The driver circuit element 6 is disposed to be adjacent to the optical modulation element 4 included in the optical waveguide device 3, and includes a drive circuit that outputs a modulation signal for causing the optical modulation element 4 to perform a modulation operation. The driver circuit element 6 is connected to the optical modulation element 4 through a predetermined wiring such as wire bonding.

The optical waveguide device 3 includes the optical modulation element 4, a microlens array 40, and a monocular lens 50.

The optical modulation element 4 is, for example, an optical functional element that performs optical modulation. The optical modulation element 4 is, for example, a configuration of a DP-QPSK modulator. The optical modulation element 4 includes an optical waveguide substrate 20 on which an optical waveguide 30 is provided. The optical waveguide substrate 20 is formed of LN, a semiconductor, or the like.

The optical waveguide 30 of a ridge type is formed on the optical waveguide substrate 20. In the present embodiment, the height dimension of the optical waveguide 30, which is a dimension along a plate thickness direction of the optical waveguide substrate 20, is set to, for example, 2 μm or lower.

The optical waveguide 30 includes an input waveguide 36 into which input light is input and two output waveguides 38 that output outputted light. In the optical waveguide 30, the propagation direction of light on the optical waveguide substrate 20 is folded back by 180 degrees.

As a result, the input end 32, which is an end portion of the input waveguide 36, and a first output end 34 and a second output end 35, which are respective output ends of the two output waveguides 38, are disposed on one end surface 22 of the optical waveguide substrate 20.

Input light is input to the input end 32, and two outputted light components which form output light are output from the first output end 34 and the second output end 35. The end surface 22 functions as a light input and output surface.

In the optical waveguide substrate 20, each of the input waveguide 36 and the output waveguide 38 extends from the end surface 22 toward an end surface 24 facing the end surface 22.

In the optical waveguide 30, a spot size converter 39 is provided at each of the input end 32, the first output end 34, and the second output end 35. The spot size converter 39 changes a mode field diameter of a light wave propagating through the optical waveguide 30. A mode field diameter of the spot size converter 39 is formed to be 4 microns or lower at end portions positioned on the side of the input end 32 and each of the first output end 34 and the second output end 35.

In the present embodiment, although the spot size converter 39 is formed on the optical waveguide substrate 20, the present invention is not limited to the configuration, and a configuration in which the spot size converter 39 is not formed may be provided.

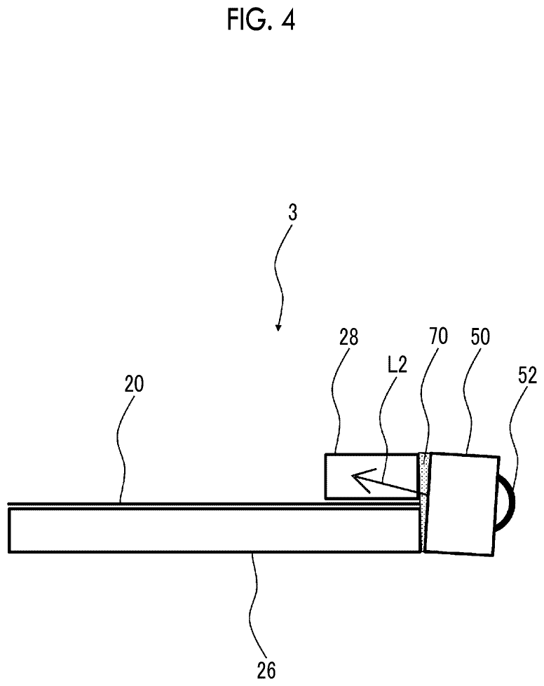

In order to increase the mechanical strength of the optical modulation element 4, a reinforcing substrate 26 is bonded to one surface of the optical waveguide substrate 20 (FIG. 4). The reinforcing substrate 26 is formed of a SiO2 substrate or the like, and a plate thickness of the reinforcing substrate 26 has a thickness dimension of, for example, about 1 mm. The reinforcing substrate 26 corresponds to a “support substrate” of the present disclosure.

A reinforcing component 28 is provided on the end surface 22 (FIG. 4). The reinforcing component 28 is provided on a surface of the optical waveguide substrate 20 on the side facing a surface to which the reinforcing substrate 26 is bonded. The reinforcing component 28 is formed of a semiconductor substrate or the like such as LN, SiO2, or Si, and a plate thickness of the reinforcing component 28 has a thickness dimension similar to that of the reinforcing substrate 26, for example.

In the optical waveguide substrate 20, the microlens array 40 is disposed on a portion of the end surface 22. In addition, the coupling lenses 14 and 15 are disposed in the input optical fiber 10 and the output optical fiber 11, respectively. A plurality of lenses are integrally formed in the microlens array 40. The microlens array 40 is an optical member that optically couples the optical waveguide 30 of the optical modulation element 4 to the input optical fiber 10 and the output optical fiber 11 together with the coupling lenses 14 and 15. In the present embodiment, the microlens array 40 is formed of a glass material and includes two lenses 42 and 44. The two lenses 42 and 44 are provided in the microlens array 40 at a predetermined distance (pitch) from each other.

The lenses 42 and 44 have substantially the same focal length, and by selecting the focal lengths of the lenses 42 and 44 and the coupling lenses 14 and 15, the mode field diameter of the spot size converter 39 can be converted into the mode field diameters of the input optical fiber 10 and the output optical fiber 11.

The microlens array 40 includes an attachment surface 46 that is a flat surface extending in a direction intersecting a focal direction of the lenses 42 and 44. The microlens array 40 is attached to the optical waveguide substrate 20 by the attachment surface 46 facing and adhering to a portion of the end surface 22 via the adhesive 70.

The adhesive 70 is, for example, a so-called photocurable resin that is cured by ultraviolet light or the like.

As described above, since the reinforcing component 28 is disposed on a portion of the end surface 22 of the optical waveguide substrate 20, it is easy to attach the microlens array 40 to the end surface 22. In addition, by providing the reinforcing component 28, the adhesion strength between the end surface 22 and the microlens array 40 is improved in the optical waveguide substrate 20.

The lens 42 of the microlens array 40 attached to the optical waveguide substrate 20 optically couples the input end 32 and the input optical fiber 10 together with the coupling lens 14, and the lens 44 optically couples the first output end 34 and the output optical fiber 11 together with the coupling lens 15.

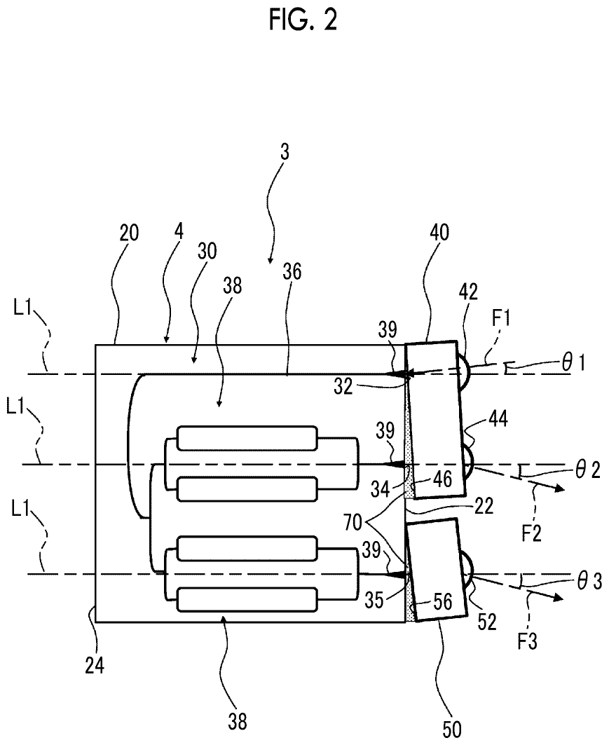

FIG. 2 is a view illustrating the optical waveguide device 3, optical axis L1 of each of the optical waveguides 30 in the end surface 22 of the optical waveguide substrate 20, and ray directions F1, F2, and F3 of the lenses 42, 44, and 52. In FIG. 2, for convenience of description, the optical axis L1 is indicated by a two-dot chain line and is indicated at a position passing through each of the lenses 42, 44, and 52. In FIG. 2, the ray directions F1, F2, and F3 of the lenses 42, 44, and 52 are indicated by an alternate long and short dash line.

The ray direction F1 illustrated in FIG. 2 indicates an optical axis direction of a ray of the input light input to the lens 42, and the ray directions F2 and F3 indicate optical axis directions of rays of the outputted light output from each of the lenses 44 and 52.

When the microlens array 40 is attached to the optical waveguide substrate 20, the attachment surface 46 is adhered to a portion of the end surface 22 such that the ray direction F1 of the lens 42 extends substantially in the same direction as the optical axis L1 of the optical waveguide 30. In other words, as illustrated in FIG. 2, the microlens array 40 is attached to the optical waveguide substrate 20 such that an angle θ1 formed between the optical axis L1 and the ray direction F1 of the lens 42 is smaller than an angle θ2 formed between the optical axis L1 and the ray direction F2 of the lens 44.

Accordingly, in the optical waveguide device 3, since it is possible to reduce the coupling loss of the input light through the lens 42 of the microlens array 40, it is possible to improve the extinction ratio characteristics of the optical waveguide device 3.

As described above, when the microlens array 40 is attached to the optical waveguide substrate 20, the lens 44 is attached such that the ray direction F2 forms the angle θ2 with respect to the optical axis L1. The angle θ2 is determined by the angle θ1, a tolerance of a pitch clearance between the lens 42 and the lens 44, and a distance between the input end 32 and the first output end 34 in a longitudinal direction of the end surface 22.

As illustrated in FIG. 1, in the optical waveguide substrate 20, the monocular lens 50 is provided on a portion of the end surface 22. The monocular lens 50 includes the lens 52 that is a single lens, and is an optical member that optically couples the output waveguide 38 of the optical modulation element 4 and the output optical fiber 11 together with the coupling lens 15. The monocular lens 50 is formed of a glass material.

The lens 52 has substantially the same focal length as the lenses 42 and 44, and by selecting the focal length of the coupling lens 15, a beam diameter of the output optical fiber 11 and a beam diameter from the spot size converter 39 can be matched.

The monocular lens 50 includes an attachment surface 56, which is a flat surface, on the opposite side of the convex surface of the lens 52. The monocular lens 50 is attached to the optical waveguide substrate 20 by the attachment surface 56 facing and adhering to a portion of the end surface 22 via the adhesive 70.

As described above, the reinforcing component 28 is provided on the end surface 22 of the optical waveguide substrate 20, so that the monocular lens 50 can be easily attached to the end surface 22.

The lens 52 of the monocular lens 50 couples the second output end 35 and the output optical fiber 11 together with the coupling lens 15.

In the case 2, a polarization combining means 8 that performs polarization combining on outputted light output from the lens 44 and the lens 52 is disposed between the optical waveguide device 3 and the output optical fiber 11. The outputted light combined by the polarization combining means 8 is coupled to the output optical fiber 11 through the coupling lens 15 and becomes the output light of the optical modulator 1.

As described above, when the microlens array 40 is attached to the optical waveguide substrate 20, the lens 44 is attached such that the ray direction F2 forms the angle θ2 with respect to the optical axis L1.

Here, when the lens 52 is provided integrally with the microlens array 40, the angle θ3 formed between the optical axis L1 and the ray direction F3 of the lens 52 is determined according to a tolerance of the pitch clearance among the lens 42, the lens 44, and the lens 52 in the microlens array 40. For example, when the focal lengths of the lenses 44 and 52 are 0.5 mm or lower, an angular difference of about 1 degree or lower occurs between the angle θ2 and the angle θ3, which are outputted light angles from the respective lenses, and an increase in optical coupling loss of 1 dB or higher is expected when two output light components are coupled to the output optical fiber 11.

As illustrated in FIG. 2, in the optical waveguide device 3 of the present embodiment, the lens 52 is separated from the lenses 42 and 44 and is provided in the monocular lens 50 that is an optical member different from the microlens array 40.

As a result, in the optical waveguide device 3, the lens 52 can be attached to the optical waveguide substrate 20 such that the predetermined angle θ3 is set regardless of the angle θ2. Therefore, in the optical waveguide device 3, it is possible to suppress the loss when the two output light components are coupled to the output optical fiber 11 as compared with a case of the microlens array in which the lenses 42, 44, and 52 are integrated.

As described above, the outputted light output from the lens 44 and the lens 52 is combined through the polarization combining means 8 and is input to the output optical fiber 11. In this case, when a position of a so-called beam waist, which is a portion at which a diameter of a beam is the smallest, is near the middle of the coupling distance in the output direction, the outputted light output from the lens 44 and the outputted light output from the lens 52 are in an optimum coupling state, and the coupling loss can be reduced. The position of the beam waist is determined by the distance between the first output end 34 and the lens 44 and the distance between the second output end 35 and the lens 52, in other words, the distance between the first output end 34 and the attachment surface 46 and the distance between the second output end 35 and the attachment surface 56.

In the optical waveguide device 3 of the present embodiment, the lens 52 is provided in the monocular lens 50 that is a separate body from the microlens array 40 provided with the lens 44.

In the optical waveguide device 3, the lens 52 is separated from the lenses 42 and 44. As a result, in the optical waveguide device 3, for example, the attachment position and/or the angle of the lens 44 can be adjusted such that the beam waist of the outputted light output from the lens 44 is set to be near the middle of the coupling distance to the output optical fiber 11. Further, in the optical waveguide device 3, the mounting position and/or the angle of the lens 52 can be adjusted separately from the lens 44 such that the beam waist of the outputted light output from the lens 52 is set to be near the middle of the coupling distance to the output optical fiber 11.

Therefore, in the optical waveguide device 3, the coupling loss between the lens 44 or the lens 52 and the output optical fiber 11 can be suppressed as compared with a case of the microlens array in which the lenses 42, 44, and 52 are integrated.

In the present example, the scattered light generated in the optical waveguide substrate 20 may enter the microlens array 40 and the monocular lens 50.

When the microlens array in which the lenses 42, 44, and 52 are integrated, there is a possibility that the scattered light entering into the lenses of each other may be input into other lenses and may deteriorate the extinction ratio of the optical waveguide device 3. On the other hand, in the present example, the lenses 42 and 44 and the lens 52 are formed separately, and an air gap is formed between the microlens array 40 and the monocular lens 50.

As a result, in the optical waveguide device 3, although the scattered light generated in the optical waveguide substrate 20 enters the microlens array 40, the scattered light is suppressed from entering the monocular lens 50. Similarly, in the optical waveguide device 3, although the scattered light generated in the optical waveguide substrate 20 enters the monocular lens 50, the scattered light is suppressed from entering the microlens array 40. Therefore, in the optical waveguide device 3, the extinction ratio can be improved, and so-called crosstalk can be improved.

Next, modification examples of the present embodiment will be described.

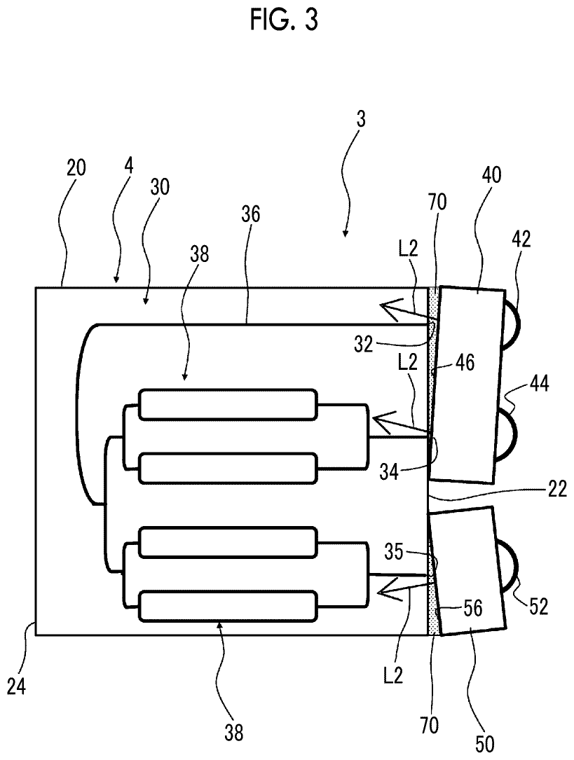

FIG. 3 is a view illustrating a configuration of the optical waveguide device 3 according to Modification Example 1 of the present embodiment. In FIG. 3, for convenience of description, the spot size converter 39 is omitted, and reflected light L2 is indicated by an arrow.

In the optical waveguide device 3 of the present modification example, the microlens array 40 is inclined and fixed to the optical waveguide substrate 20 such that the reflected light L2 generated by each of the lens 42 and the lens 44 is not directed in the direction of the optical waveguide 30 to which the lens 52 is be coupled. Similarly, in the optical waveguide device 3, the monocular lens 50 is inclined and fixed to the optical waveguide substrate 20 such that the reflected light L2 generated by the lens 52 is not directed in the direction of the optical waveguide 30 to which the lens 42 or 44 is coupled.

As a result, in the optical waveguide device 3, the crosstalk between the optical waveguides 30 can be suppressed. In particular, in the present modification example, since the crosstalk between the two optical waveguides 30 for output coupled to the lenses 44 and 52 is suppressed, more excellent characteristics of the optical waveguide device can be obtained.

In the present modification example, the optical waveguide device 3 is formed such that both the angle formed between the end surface 22 and the attachment surface 56 and the angle formed between the end surface 22 and the attachment surface 46 are 10 degrees or lower.

The angle formed between the end surface 22 and the attachment surface 56 and the angle formed between the end surface 22 and the attachment surface 46 may be 5 degrees or less, 3 degrees or less, or 1 degree or lower.

FIG. 4 is a view illustrating a configuration of the optical waveguide device 3 according to Modification Example 2 of the present embodiment.

As illustrated in FIG. 4, in the present modification example, the microlens array 40 and the monocular lens 50 are attached to the optical waveguide substrate 20 such that the reflected light L2 is directed toward the reinforcing component 28.

Here, in the optical waveguide device 3, it is possible to attach the monocular lens 50 to the optical waveguide substrate 20 such that the reflected light L2 is directed toward the reinforcing substrate 26. However, in such an optical waveguide device 3, the reflected light L2 propagates inside the reinforcing substrate 26, and there is a possibility that the crosstalk characteristics are deteriorated.

The optical waveguide device 3 of the present modification example is formed such that the monocular lens 50 is attached to the optical waveguide substrate 20 as illustrated in FIG. 4 and thus the reflected light L2 on the attachment surface 56 is directed in a direction away from the reinforcing substrate 26. As a result, in the optical waveguide device 3, the deterioration of the crosstalk characteristics can be suppressed, and more excellent characteristics of the optical waveguide device can be obtained.

As described above, in the optical waveguide device 3, the microlens array 40 is attached to the optical waveguide substrate 20 such that the reflected light on the attachment surface 46 is directed in a direction away from the reinforcing substrate 26.

In addition, at least one of the microlens array 40 or the monocular lens 50 may be attached to the optical waveguide substrate 20 such that the inclination illustrated in FIG. 3 and the inclination illustrated in FIG. 4 are simultaneously satisfied. As a result, in the optical waveguide device 3, the crosstalk characteristics are further improved.

### Second Embodiment

Next, a second embodiment of the present invention will be described.

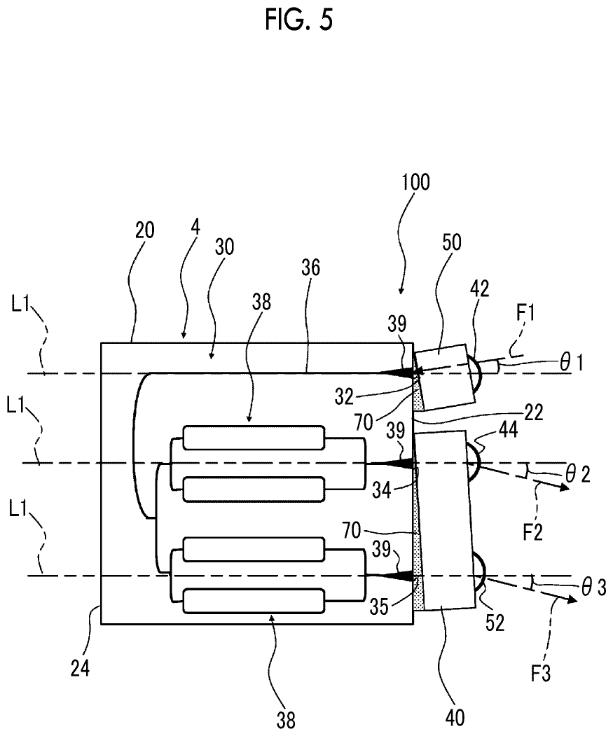

FIG. 5 is a diagram illustrating a configuration of an optical waveguide device 100 according to the second embodiment of the present invention. In FIG. 5, the same parts as those in FIG. 1 are denoted by the same reference numerals, and the description of the same parts will be omitted.

The optical waveguide device 100 illustrated in FIG. 5 is provided in the optical modulator 1, and is housed in the case 2 in which the input optical fiber 10 and the output optical fiber 11 are provided, similarly to the optical waveguide device 3 illustrated in FIG. 1.

As illustrated in FIG. 5, in the optical waveguide device 100 of the present embodiment, the monocular lens 50 includes the lens 42, and the microlens array 40 integrally includes the lens 44 and the lens 52.

In the optical waveguide device 100, the lens 44 of the microlens array 40 optically couples the first output end 34 and the output optical fiber 11 together with the coupling lens 15. Similarly, the lens 52 of the microlens array 40 optically couples the second output end 35 and the output optical fiber 11 together with the coupling lens 15.

The lens 42 of the monocular lens 50 optically couples the input end 32 and the input optical fiber 10 together with the coupling lens 14.

As a result, in the optical waveguide device 100, regardless of the angle θ1 formed between the optical axis L1 and the ray direction F1 of the lens 42, the angle θ2 formed between the optical axis L1 and the ray direction F2 of the lens 44 and the angle θ3 formed between the optical axis L1 and the ray direction F3 of the lens 52 can be determined. Therefore, in the optical waveguide device 100, the optical coupling loss in the lens 42 can be reduced.

In the lenses 44 and 52, since the respective outputted light components are coupled to the one output optical fiber 11, it is necessary to adjust the angle and the position of the lens 44 or the lens 52. In the optical waveguide device 100 of the present embodiment, since the lenses 44 and 52 are independent of the lens 42, the alignment of the lenses 44 and 52 can be simplified. Therefore, in the optical waveguide device 100, the input intensity of the outputted light output from each of the lenses 44 and 52 with respect to the output optical fiber 11 can be adjusted.

Here, as in the above-described embodiments 1 and 2, in the optical waveguide 30 of a ridge type, the configuration in which the spot size converter 39 is provided requires adjustment of the lens with higher accuracy.

Therefore, the optical waveguide devices 3 and 100 in which the degree of freedom is provided in the range of the optical coupling adjustment are suitable for an optical waveguide configuration in which the mode field diameter is 5 μm or lower, 3 μm or lower, or further 2 μm or lower.

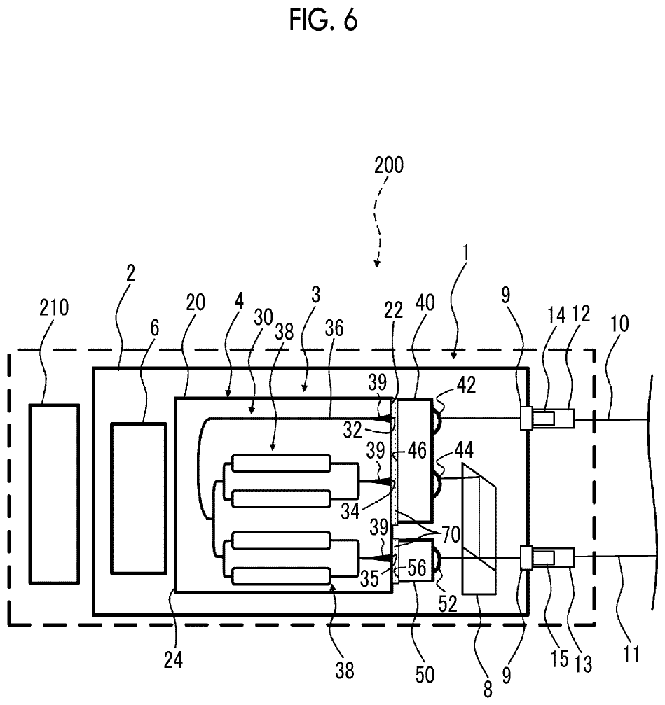

FIG. 6 is a diagram illustrating a configuration of an optical transmission apparatus 200 according to the present invention.

As illustrated in FIGS. 1 and 5, in the above-described embodiments 1 and 2, the optical modulator 1 can be formed by accommodating the optical waveguide devices 3 and 100 as described above inside the case 2 and providing an optical fiber, which inputs a light wave or outputs a light wave from the outside of the case 2, in the optical waveguide 30 of the optical modulation element 4.

As illustrated in FIG. 6, in the above-described embodiments 1 and 2, the optical transmission apparatus 200 can be configured by the optical modulator 1 including a digital signal processing processor that generates an electrical signal input to the optical waveguide substrate 20, an electronic circuit 210 configured with a driver IC or the like, a laser light source, a control circuit, or the like. The electronic circuit 210 may be disposed inside the same case 2 as the optical waveguide device is, or may be disposed outside the case 2 as illustrated in FIG. 6.

However, the above-described embodiment is an aspect of the present invention, and it is needless to say that the embodiment can be appropriately changed without departing from the gist of the present invention. In addition, it is also possible to configure other embodiments by combining the respective configurations described in the embodiments 1 and 2.

For example, in the above-described embodiments 1 and 2, a light source such as a light emitting element such as a laser diode may be attached to the input end 32 instead of the input optical fiber 10.

In addition, for example, in the above-described embodiments 1 and 2, although the one input end 32 and the two output ends are provided in the optical waveguide substrate 20, the present invention is not limited the configuration, and a plurality of input ends or one or three or more output ends may be provided in the optical waveguide substrate 20.

Unless otherwise specified, the directions such as horizontal and vertical, and the various numerical values and shapes in the above-described embodiments include a so-called equivalent range in which the same action and effect is achieved as those directions, numerical values, and shapes.

### REFERENCE SIGNS LIST

1: Optical modulator
2: Case
3, 100: Optical waveguide device
4: Optical modulation element
9: Optical window
10: Input optical fiber (optical fiber)
11: Output optical fiber (optical fiber)
14, 15: Coupling lens
42, 44, 52: Lens
20: Optical waveguide substrate
22, 24: End surface
30: Optical waveguide
32: Input end (end portion)
34: First output end (end portion)
35: Second output end (end portion)
36: Input waveguide
38: Output waveguide
39: Spot size converter
40: Microlens array
46, 56: Attachment surface
50: Monocular lens
70: Adhesive

1-cm 9. (canceled)

10. An optical waveguide device comprising:
an optical waveguide substrate on which an optical waveguide is provided; and
a plurality of lenses that optically couple the optical waveguide and an optical fiber,
wherein the optical waveguide includes at least one input waveguide to which input light is input and at least two output waveguides that output outputted light which forms output light,
an end portion of the input waveguide and an end portion of the output waveguide are formed on one same end surface of the optical waveguide substrate,
at least three lenses respectively corresponding to the at least one input waveguide and the at least two output waveguides are disposed on the end surface, and
the at least three lenses are configured with a lens array in which at least two lenses are integrally formed and a single lens.

11. The optical waveguide device according to claim 10,
wherein the lens corresponding to the input waveguide and the lens corresponding to the one output waveguide are integrally formed in the lens array.

12. The optical waveguide device according to claim 10,
wherein the lenses corresponding to the at least two output waveguides are integrally formed in the lens array.

13. The optical waveguide device according to claim 10,
wherein the two output waveguides are provided on the optical waveguide substrate, and
the two lenses respectively corresponding to the two output waveguides are integrally formed in the lens array.

14. The optical waveguide device according to claim 10,
wherein an angle of the input light with respect to an optical axis of the input waveguide is smaller than an angle of the output light with respect to an optical axis of the output waveguide.

15. The optical waveguide device according to claim 10,
wherein a lens corresponding to each of the two output waveguides includes an attachment surface that is attached to face the end surface, and
the attachment surface is attached to the end surface such that reflected light of the output light from each of the output waveguides on the attachment surface is directed in a direction away from a direction of the other output waveguide.

16. The optical waveguide device according to claim 10,
wherein the optical waveguide substrate is bonded to a support substrate,
the lens includes an attachment surface that is attached to face the end surface, and
the attachment surface is attached to the end surface such that reflected light of the output light from each of the output waveguides on the attachment surface is directed in a direction away from the support substrate.

17. An optical modulator comprising:
the optical waveguide device according to claim 10;
a case that accommodates the optical waveguide device; and
an optical fiber that inputs a light wave to the optical waveguide or outputs a light wave from the optical waveguide from an outside of the case.

18. An optical transmission apparatus comprising:
the optical modulator according to claim 17; and
an electronic circuit that outputs a modulation signal for causing the optical modulator to perform a modulation operation.
